(19) United States
(12) Patent Application Publication
(10) Pub. No.: US 2004/0054624 A1
(43) Pub. Date: Mar. 18, 2004

(54) Procedure for the completion of an electronic payment

(76) Inventors: Qi Guan, Wien (AT); Markus Lenger, Wien (AT); Marcel Vencour, Wien (AT)

Correspondence Address: Kevin R. Spivak, Morrison & Foerster LLP, Suite 300, 1650 Tysons Boulevard, McLean, VA, 22102, US

(21) Appl. No.: 10/242,660

(22) Filed: Sep. 13, 2002

(51) Int. Cl. G06F 17/60

(52) U.S. Cl. 705/40; 705/39; 705/37

(57) ABSTRACT

The invention relates to a method for processing a payment operation via a credit card financial service provider in electronic commerce in an open network, particularly on the Internet, between a purchaser and a trader, where the credit card financial service provider transmits a transaction code which is valid for one payment operation to the purchaser at the latter's request, and the purchaser uses this transaction code instead of his credit card number when processing the payment operation with the traders.

### TECHNICAL FIELD OF THE INVENTION

The invention relates to a method for processing a payment operation in electronic commerce in a communication network, particularly on the Internet, between a purchaser and a trader via a credit card financial service provider.

### BACKGROUND OF THE INVENTION

Payments using credit cards are common. The credit card is currently the only payment type which is accepted worldwide. Anyone paying with a credit card does not require a secret number—physical possession and a signature are sufficient. Increasingly, payments using credit cards are also being processed in public networks, such as on the Internet, or in mobile radio networks. However, the openness and transparency of the Internet carries the risk that sensitive data will be observed and possibly misused. Business transactions on the Internet can work satisfactorily only if the payment operation is largely protected against misuse both for the purchaser and for the vendor, however. Broad acceptance of electronic payments can be expected only if there is a relationship of trust between the parties involved and the payment operation is as free from risk as possible.

If, by way of example, the credit card number is intercepted on the Internet, the observer will have no difficulty in making purchases wherever he remains anonymous. Although the holder of the credit card usually has the opportunity to cancel the payment in the event of misuse being identified, the risk remains for the trader that the card institution will not pay him for a service which has been provided and which has possibly been consumed directly. Particularly the transmission of confidential data over the Internet, such as the credit card number, is perceived by the purchaser to be a central security problem.

The number of complaints relating to credit card transactions over the Internet is also an enormous economic risk for the credit institutions involved in processing an online payment operation.

On account of the lack of technical security for the transaction, all parties involved are therefore still critical of a financial online transaction on the Internet.

For the purpose of transmitting data securely, various encryption methods have been developed. A common method is the SSL (Secure Socket Layer) protocol. SSL is a standard for transmitting confidential data in networks. Although it provides adequate protection against interception of confidential data, such as credit card data, or against data being altered by third parties, it is of central significance to secure payment on the Internet that there is prevailing certainty of both the purchaser and the trader actually being authorized to process payments using a card, and that these are legally binding. SSL does not permit authentication of the participants, however.

The security standard SET (Secure Electronic Transaction) is regarded as being the currently most secure payment method for purchaser and trader in an open network. SET is a specification which is specifically oriented to financial transactions. Authentication is performed using an electronic signature, the “digital signature”. SET ensures both the confidentiality and encryption of the transmitted information. This means that it is firstly ensured that no-one in the virtual world has access to information which is not intended for him. Secondly, the transmitted information is made unreadable for third parties using a cryptographic method. The result of this is that the trader sees neither the customer's account data nor his card status. Conversely, the institution concerned with the financial transaction does not receive any information about the type and content of the order. However, carrying out an SET payment method is linked to a series of requirements on the Internet. Firstly, specific software components are required which need to be installed on the interface to the public network. That is, both the purchaser and the trader require “plug-ins” in the browser, or specific software components which need to be incorporated in the operating system.

Secondly, the parties involved are required to accept a central certification agency which uniquely identifies the market partners and checks all the software products used for acceptance in order to ensure the security standard and quality standard of the SET payment method.

It is regarded as a drawback of SET that it is technically complex and financially disadvantageous. This is a particular drawback on the Internet for the “micropayment” and “picopayment” areas, which involve sums below ε5.00 and ε1, respectively. This area of payment is experiencing high growth rates on the Internet, however. The complexity of the system also prevents integration in many old systems used in banks and for credit card systems.

In particular, the need for both the purchaser and the vendor to install specific software, which often needs to be paid for, is regarded as a drawback by the parties involved.

FIG. 1 shows the sequence of a payment operation in the manner in which it is normally processed in an open network ON, such as on the Internet, with the input of a credit card number. The sequence is identified by arrows bearing the reference symbols 1 to 5. A customer C sends his credit card number, his name, his invoice address and other information relating to the financial transaction to the dealer M over the Internet ON (1). The dealer M sends information relating to the financial transaction to his bank MB (2) . This dealer bank MB forwards the information over a credit card/bank network BN to a bank IB which has issued the credit card for the customer C (3). Following a checking operation, this card-issuing bank IB notifies the bank of the dealer MB, over the credit card/bank network BN, of its decision regarding whether it confirms the transaction (4). The dealer M is informed (5) by his bank MB if this confirmation is available. If this is the case, the dealer M executes the order request. After a prescribed unit of time, the dealer M asks his credit institute MB to debit the appropriate sum of money for the transaction to the customer's bank IB. This is again done by means of a request over the bank network BN to the bank IB of the customer C. The transaction ends when the customer's card-issuing bank IB posts the price of the goods minus the bank and service charges to the dealer bank MB. The account belonging to the card-issuing bank IB of the customer C now shows the sum debited for the dealer M, although this sum is not actually paid by the customer C until at a later time.

### SUMMARY OF THE INVENTION

The present invention discloses a method for processing a payment operation in an open network such that the parties involved are assured of a very high degree of security without the need to make complex changes on the communication devices.

In one embodiment of the invention, a credit card financial service provider, i.e. an institution concerned with the financial transaction or a conventional credit card system, produces, at the request of a purchaser, at least one transaction code and transmits it to the purchaser, and the purchaser uses this at least one transaction code instead of a credit card number when dealing with a trader. Thus, no credit card number is used in the network for the payment operation, but rather a converted form thereof. The transaction code is intended for processing one financial transaction and is valid for the trader involved in the transaction. The transaction code is very similar to the customary transaction number, the “TAN”, as sent from time to time by a bank to its customers for telebanking applications in the form of lists for the purpose of processing bank transactions, when the payment operation. Since the purchaser does not transmit his credit card number to the vendor over the insecure Internet, the credit card customer's actual number cannot be misused. The use of this once-valid number minimizes the risk in payment processing for the purchaser. Between the purchaser and the Internet shop or a content provider, the inventive method improves the confidence in processing a transaction.

An advantage in this case is that neither the purchaser nor the trader needs to install new software additionally, and no new agreements need to be signed with credit card companies.

Since the transaction code is treated like a credit card number, the interoperability between different hardware and software systems is ensured. This opens up additional business opportunities for the corresponding credit card companies, but particularly for the credit card provider or possibly for the Internet Service Provider. The credit card provider appears in the role of an agent between the credit card company and the end customer, the purchaser.

Since the credit card financial service provider recognizes the transaction code to be valid within a limited time interval, security when processing the financial transaction is improved further. Although it is possible, to crack any algorithm for encryption by simply trying out all possible keys, the comparatively short time available means that the risk of the transaction code being misused is very low.

The time can be limited simply by virtue of the time interval starting upon the purchaser's request and ending upon expiry of a session time between the credit card financial service provider and the purchaser. It is particularly beneficial if the credit card financial service provider limits the time interval to less than one hour.

The security for requesting and transmitting the transaction code between the purchaser and the credit institution can advantageously be increased if the credit card financial service provider transmits the transaction code to the purchaser using a cryptographic protocol. In this context, it is beneficial if the transaction code is transmitted in encrypted form and the purchaser is authenticated by a digital signature. It is also conceivable for the purchaser to become credible with the credit card financial service provider by input of a user name and/or a password.

It is of particular advantage if the credit card financial service provider is an Internet Service Provider. This means that existing business relations between a purchaser and an Internet Service Provider can be taken as a basis for processing a payment operation even if the purchaser has not signed any agreement with any of the trader's credit card institutions.

Incorporation into existing systems is a simple matter particularly if the transaction code comprises a succession of digits whose number corresponds to the number of digits in customary credit card numbers.

### BRIEF DESCRIPTION OF THE DRAWINGS

The invention is explained further with reference to the drawings, the figures of which schematically show embodiments of the invention. In the figures:

FIG. 1 shows a schematic illustration of the conventional processing of a payment operation on the Internet, where the purchaser uses his credit card number in the network.

FIG. 2. shows a schematic illustration of the sequence of a first exemplary embodiment of the invention, where the purchaser holds the dealer's appropriate credit card.

FIG. 3 shows a schematic illustration of the sequence of a second exemplary embodiment of the invention, where the purchaser does not hold the dealer's appropriate credit card.

### DETAILED DESCRIPTION OF THE PREFERRED EMBODIMENTS

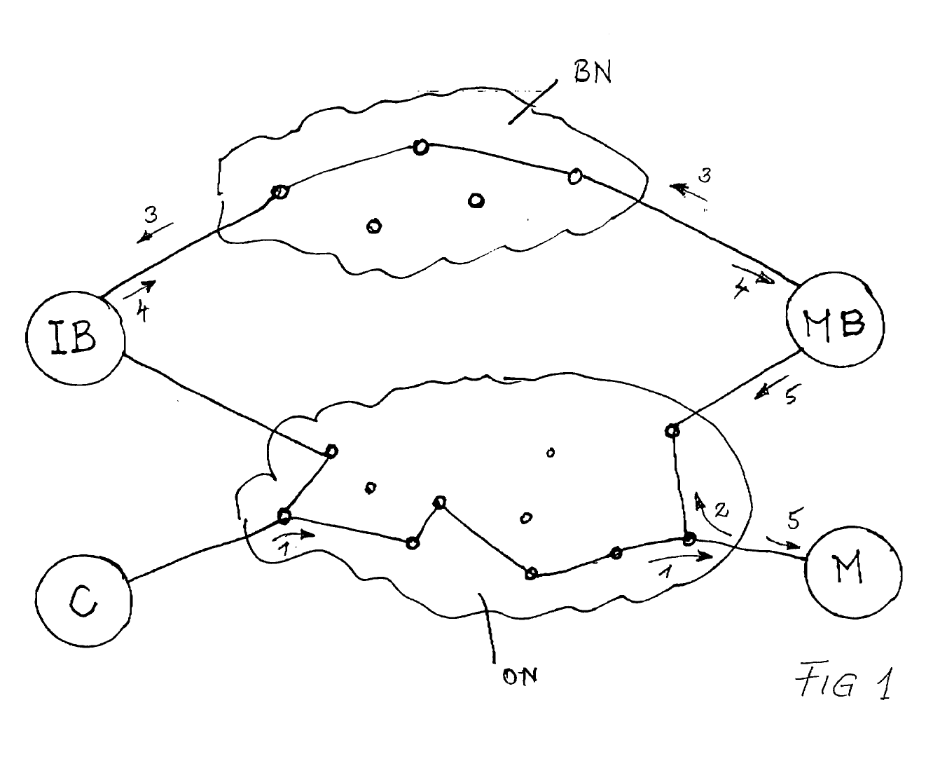

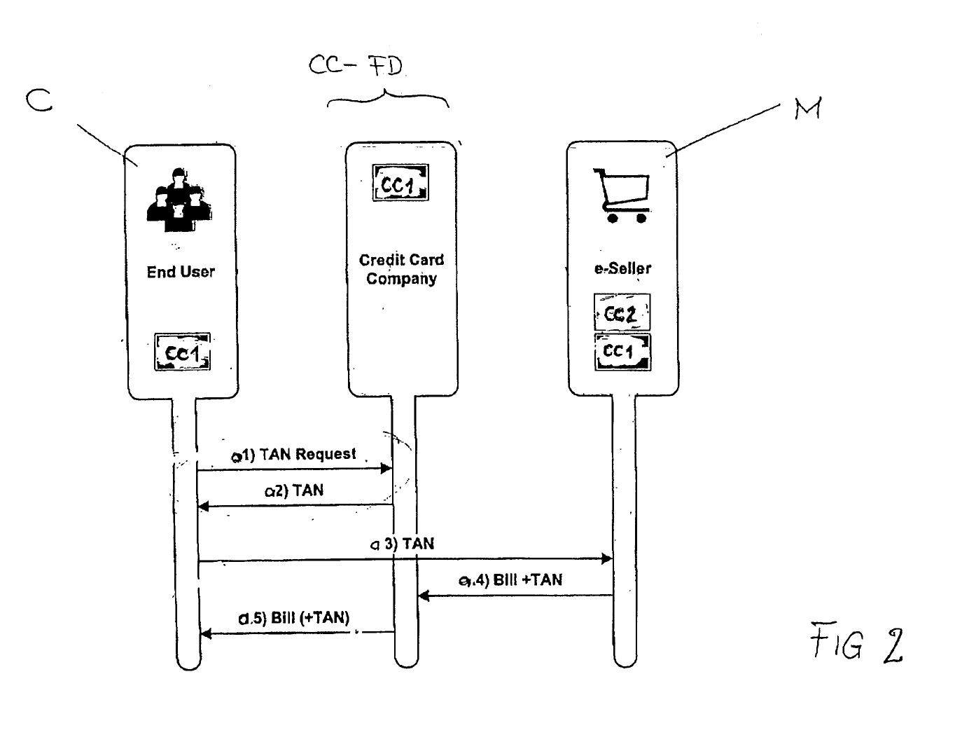

FIG. 2 shows a first embodiment of the sequence of the invention. The purchaser C—this is the “end user” in the illustration in FIG. 1—has loaded his virtual shopping basket with products which he would like to pay for with the dealer M, “e-seller” in FIG. 1. He holds the credit card CC1. The purchaser C is registered with a credit card financial service provider CC-FD, “Credit Card Company” in FIG. 1. The sequence of the communication when processing the payment operation is shown in FIG. 2 by arrows bearing the reference symbols a1) to a5).

When paying, the purchaser C selects the credit card payment mode on the dealer's web page, after which the payment mode presents various credit cards which can be accepted—these are the credit cards from the card institutions CC1 and CC2 in FIG. 2. In our example, the Internet purchaser is a customer of a suitable credit card company CC1. To process the payment operation, the Internet purchaser now applies for a transaction code (al TAN Request) from his credit card company (CC1) in line with the invention. Upon this request, the credit card institution CC1 establishes the identity of the requesting person and his authorization to perform a financial transaction (authentication) . As soon as the credit card company CC1 has identified the authorization of his customer, the end user in FIG. 2, it generates a transaction code. This involves either converting every character in the credit card number into another character from another alphabet or producing a new image set. When the transaction code has been produced, it is transmitted to the purchaser (a2 TAN) . Both the request from the Internet user and the transmission of the transaction code from the credit card company to the Internet user are preferably processed using a cryptographic protocol. The protocol S-HTTP is particularly suitable for this purpose. This protocol allows authentication by digital signatures and encryption of the messages to be transmitted in both directions. The protocol S-HTTP is a standard of the Internet Engineering Task Force. In continuation of the processing of the payment operation, the Internet purchaser C transmits the transaction code to the vendor M in (a3 TAN) . For this, he proceeds in the same way as if a credit card number were involved. The dealer M also treats the transaction code as a credit card number and transmits the amount of the invoice together with the transaction code to the credit card company (a4 Bill+TAN). When the credit card financial service provider CC-FD has paid the amount of the invoice to the vendor, the vendor M delivers the goods. In (a5 Bill(+TAN)), the credit card company informs the Internet purchaser about the amount of the invoice which is to be paid. If the Internet purchaser recognizes his initiated order operation therein and acknowledges it, the payment operation is at an end. The credit card financial service provider CC-FD pays the amount of the invoice to the vendor M. The invention is therefore characterized by the use of a transaction code which is generated during the payment operation and acts as a “temporary credit card number”. Since this transaction code has a very short life span, misuse is largely precluded. Since its use is treated as a credit card number, it is not necessary for the trading partners C and M to be certified or to install certified software on their communication devices. The provision of accounts by the vendor M to the credit card company (Credit Card Company) also requires no new procedures, but rather is done conventionally. The difference is that the transaction code instead of the customary credit card number now appears on the invoice. The credit card company can use this transaction code to associate the end customer. The credit card company's further provision of accounts to the end customer is also processed conventionally. The account of the customer C is normally debited at a later time.

It will be noted that the purchaser can also order a plurality of TANs from the credit card company in advance. This has the advantage that it is not necessary to send an individual request to the credit card company for every purchase.

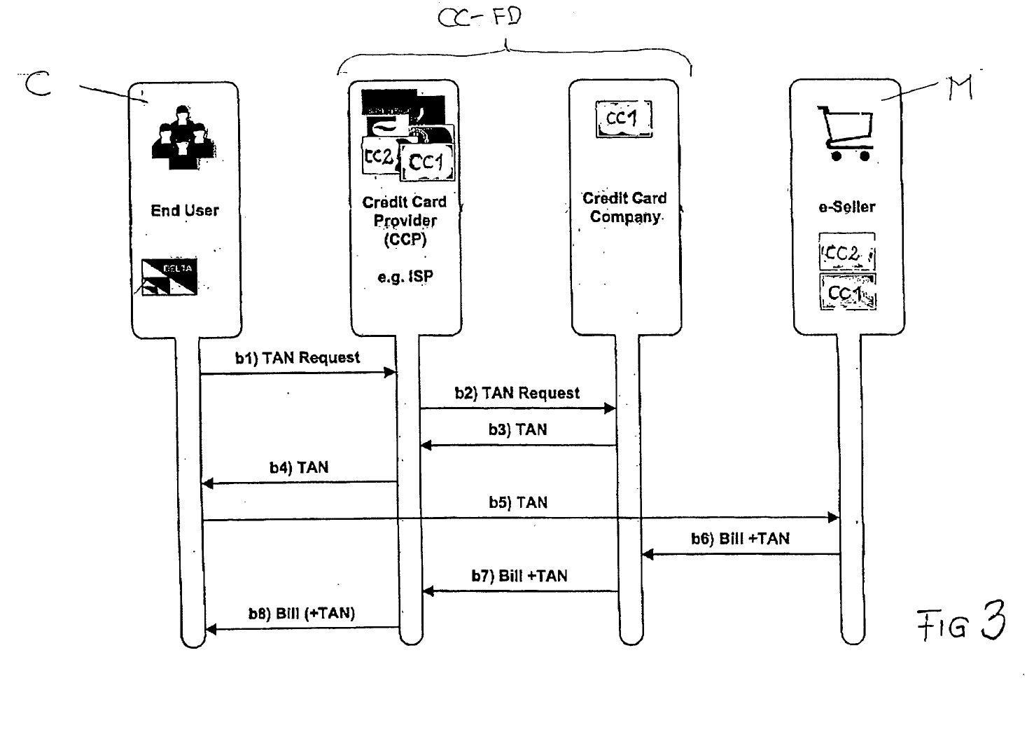

In a second exemplary embodiment of the invention, the schematic sequence of which is shown in FIG. 3, a “credit card provider”, Credit Card Provider CCP, is interposed between the end customer C and the credit card company, Credit Card Company. In this case, the credit card financial service provider thus comprises the credit card provider and the credit card company. The credit card provider CCP can be an Internet Service Provider ISP, for example. In this case too, the customer C wishes to pay for goods or a service which he has selected over the Internet with the trader M. To this end, he selects the payment method via a particular credit card company, of which he does not need to be a customer, however. A requirement for processing the payment is that the purchaser C is a customer of a credit card provider CCP which either provides an appropriate credit card in its range or handles matters through the agreement with the purchaser C. In this exemplary embodiment, the credit card provider CCP is thus itself a customer of a credit card company, Credit Card Company. The payment operation is processed in a similar manner to that explained in FIG. 2: the purchaser, that is the end customer, orders (b1 TAN Request) from his credit card provider a transaction code which is valid just for a single financial transaction. The credit card provider CCP, for its part, orders (b2 TAN Request) a transaction code which is valid once from a credit card company of which he, but not the purchaser, is a customer. This credit card company authenticates the credit card provider CCP. If the credit card provider CCP is found to be genuine, that is authentic, the credit card company produces a transaction code which is valid for one payment processing operation and transmits (b3 TAN) this code to the credit card provider. The credit card provider receives this information and sends (b4 TAN) it on to the end customer, the purchaser C. The end customer C uses this forwarded set of characters instead of the conventional credit card number for the payment operation on the web page of the vendor M. To this end, he transmits (b5 TAN) the transaction code to the vendor M. The vendor M again provides accounts to the credit card company, Credit Card Company, in a conventional manner, the primary difference being that the transaction code instead of the customary credit card number is now transmitted together with the invoice (b6 Bill+TAN) . The transaction code allows the credit card company to ascertain the credit card provider. The credit card company can then provide accounts to the credit card provider in a known manner again (b7 Bill+TAN) . In this context, the transaction code is used for associating the end customer with the credit card provider. Another option is provided by a B2B, that is a Business to Business interface. Then, the credit card provider ascertains the end customer from the transaction code. The credit card provider provides accounts to the end customer in the same way as this occurs between a credit card company and an end customer ((b8 Bill(+TAN)).

The purchaser can also request a plurality of TANs from the credit card provider in advance. This has the advantage that a TAN Request does not need to be sent to the CCP for every purchase. It goes without saying that the credit card provider CCP can also request a plurality of TANs from the credit card company in advance. This also has the advantage that it is not necessary to set up a connection to the credit card company for a single TAN request whenever the purchaser makes a TAN request.

What is claimed is:

1. A method for processing a payment operation in electronic commerce in a communication network, between a purchaser and a trader via a credit card financial service provider, wherein the credit card financial service provider produces, at the request of the purchaser, at least one transaction code and transmits the at least one transaction code to the purchaser, and the purchaser uses the at least one transaction code instead of a credit card number during transactions with the trader.

2. The method as claimed in claim 1, wherein the credit card financial service provider is a credit card company.

3. The method as claimed in claim 1, wherein the credit card financial service provider is a credit card provider.

4. The method as claimed in claim 2, wherein the credit card financial service provider recognizes the transaction code to be valid within a prescribable time interval for processing the payment operation.

5. The method as claimed in claim 4, wherein the time interval starts upon the purchaser's request and ends upon expiry of a session time between the credit card financial service provider and the purchaser.

6. The method as claimed in claim 4, wherein the credit card financial service provider limits the time interval to less than one hour.

7. The method as claimed in claim 1, wherein the credit card financial service provider transmits the transaction code to the purchaser using a cryptographic protocol.

8. The method as claimed in claim 1, wherein the transaction code is transmitted in encrypted form and the purchaser is authenticated by a digital signature or by input of user name and password.

9. The method as claimed in claim 1, wherein the credit card financial service provider is an Internet Service Provider.

10. The method as claimed in claim 1, wherein the transaction code comprises a succession of digits.

11. The method as claimed in claim 3, wherein the credit card financial service provider recognizes the transaction code to be valid within a prescribable time interval for processing the payment operation.

12. The method as claimed in claim 5, wherein the credit card financial service provider limits the time interval to less than one hour.
